(19) United States
(12) Patent Application Publication
(10) Pub. No.: US 2015/0147969 A1
(43) Pub. Date: May 28, 2015

(54) DATA TRANSMISSION METHOD AND DATA TRANSMISSION APPARATUS

(71) Applicant: Lenovo (Beijing) Co., Ltd., Beijing (CN)

(72) Inventors: Weidong Wei, Beijing (CN); Hui Wang, Beijing (CN)

(73) Assignee: Lenovo (Beijing) Co., Ltd., Beijing (CN)

(21) Appl. No.: 14/228,533

(22) Filed: Mar. 28, 2014

(30) Foreign Application Priority Data
Nov. 25, 2013 (CN) 201310607238.6

(51) Int. Cl. H04W 76/02; H04W 4/00; H04W 8/00

(52) U.S. Cl. CPC H04W 76/023; H04W 8/005; H04W 4/008
USPC 455/41.2

(57) ABSTRACT

A data transmission method and a data transmission apparatus are provided. The method is applied to a first electronic device, and includes: determining first data to be transmitted in the first electronic device; monitoring whether a second electronic device is located in a preset distance from the first electronic device; and sending the first data to the second electronic device through a first wireless transmission channel directly connected between the first electronic device and the second electronic device, in the case where the second electronic device is located in the preset distance from the first electronic device. The method may reduce the complexity of data transmission.

This application claims the priority to Chinese Patent Application No. 201310607238.6, entitled “DATA TRANSMISSION METHOD AND DATA TRANSMISSION APPARATUS”, filed with the Chinese Patent Office on Nov. 25, 2013, which is incorporated by reference in its entirety herein.

### FIELD

The disclosure relates to the field of communication technology, and more particularly to a data transmission method and a data transmission apparatus.

### BACKGROUND

With the popularization of Internet, a data transmission over a network has become very common. However, in the data transmission over the network, the data transmission may be affected if the network is in a poor condition or is unable to be connected.

To transmit data more efficiently, short-distance transmission technology has been widely used to implement an efficient transmission of data within a short-distance. For example, a device A may establish a wireless data transmission channel with another device B located in a specified distance from the device A, and the device A may transmit data from the device A to the device B through the wireless data transmission channel. However, in a short-distance data transmission, the short-distance data transmission may be completed by selecting data to be sent and a receiver of data in a timely manner by the user and triggering a data transmission by a corresponding operation. Thus, an operation process of short-distance data transmission is complicated.

### SUMMARY

In view of this, a data transmission method and a data transmission apparatus are provided, to reduce complexity of data transmission.

In one aspect, the disclosure provides the following technical solutions. A data transmission method applied to a first electronic device includes:

determining first data to be transmitted in the first electronic device;

monitoring whether a second electronic device is located in a preset distance from the first electronic device; and

sending the first data to the second electronic device through a first wireless transmission channel directly connected between the first electronic device and the second electronic device, in the case where the second electronic device is located in the preset distance from the first electronic device.

Preferably, before the monitoring whether a second electronic device is located in a preset distance from the first electronic device, the method further includes:

obtaining information of at least one second electronic device with a right for receiving the first data; and

the monitoring whether a second electronic device is located in a preset distance from the first electronic device includes:

monitoring whether a second electronic device corresponding to the information is located in the preset distance from the first electronic device.

Preferably, the monitoring whether a second electronic device corresponding to the information is located in a preset distance from the first electronic device includes:

monitoring whether a second electronic device corresponding to the information is located in the preset distance from the first electronic device at a current moment; and

the sending the first data to the second electronic device through a first wireless transmission channel directly connected between the first electronic device and the second electronic device, in the case where the second electronic device is located in the preset distance from the first electronic device includes:

sending the first data to the second electronic device through a first wireless transmission channel directly connected between the first electronic device and the second electronic device, in the case where the second electronic device is located in the preset distance from the first electronic device at the current moment.

Preferably, the method further includes: in the case where there is not the second electronic device in the preset distance from the first electronic device at the current moment, establishing a second transmission channel between the first electronic device and a predetermined server, and sending second data to the predetermined server through the second transmission channel, wherein the second electronic device obtains the second data via the specified server, and an amount of information in the second data is the same as an amount of information in the first data.

Preferably, the second data is the same as the first data.

Preferably, in the case where there is not the second electronic device in the preset distance from the first electronic device at the current moment, before the sending second data to the predetermined server through the second transmission channel, the method further includes:

processing the first data to obtain the second data, wherein a data quantity of the second data is less than a data quantity of the first data.

Preferably, after the sending second data to the predetermined server through the second transmission channel, the method further includes:

transmitting the first data to the second electronic device through the first wireless transmission channel directly connected between the first electronic device and the second electronic device, in the case where it is detected that the second electronic device is located in the preset distance from the first electronic device.

Preferably, the monitoring whether a second electronic device is located in a preset distance from the first electronic device includes:

monitoring whether a second electronic device corresponding to the information is located in a preset distance from the first electronic device, until the second electronic device in the preset distance is monitored.

Preferably, the determining first data to be transmitted in the first electronic device includes:

determining the first data set as transmission data in the first electronic device; and

the monitoring whether a second electronic device is located in a preset distance from the first electronic device includes:

monitoring whether at least one second electronic device is located in the preset distance from the first electronic device, in the case that it is detected that a predetermined condition is met at a current moment.

Preferably, a first data transmission moment corresponds to the first data; and

the monitoring whether at least one second electronic device is located in a preset distance from the first electronic device, in the case that it is detected that a predetermined condition is met at a current moment includes:

monitoring whether at least one second electronic device is located in a preset distance from the first electronic device, at the first data transmission moment corresponding to the first data.

Preferably, before the monitoring whether a second electronic device is located in a preset distance from the first electronic device, the method further includes:

setting a wireless communication module of the first electronic device as a wireless access point, wherein a signal sent by the wireless access point covers a preset distance from the first electronic device; and

the monitoring whether a second electronic device is located in a preset distance from the first electronic device includes:

monitoring whether the second electronic device establishing the first wireless transmission channel directly connected to the wireless access point is located in the preset distance.

Preferably, the monitoring whether a second electronic device is located in a preset distance from the first electronic device includes:

monitoring whether a second electronic device serving as a wireless access point is located in a preset distance from the first electronic device, wherein a wireless communication module of the second electronic device serves as the wireless access point, and a signal sent by the wireless access point at least covers a preset distance from the second electronic device; and

the sending the first data to the second electronic device through a first wireless transmission channel directly connected between the first electronic device and the second electronic device, in the case where the second electronic device is located in the preset distance from the first electronic device includes:

establishing a first wireless transmission channel directly connected between the first electronic device and the wireless access point, in the case where the second electronic device is monitored; and

sending the first data to the second electronic device through the first wireless transmission channel.

In another aspect, a data transmission apparatus is provided, which is applied to a first electronic device. The data transmission apparatus includes:

a determination unit configured to determine first data to be transmitted in the first electronic device;

a monitoring unit configured to monitor whether a second electronic device is located in a preset distance from the first electronic device; and

a short-distance transmission unit configured to send the first data determined by the determination unit to the second electronic device through a first wireless transmission channel directly connected between the first electronic device and the second electronic device, in the case where the monitoring unit monitors the second electronic device in the preset distance from the first electronic device.

Preferably, the apparatus further includes:

an information obtaining unit configured to obtain information of at least one second electronic device with a right for receiving the first data determined by the determination unit; and

the monitoring unit includes:

a monitoring sub-unit configured to monitor whether a second electronic device corresponding to the information obtained by the information obtaining unit is located in a preset distance from the first electronic device.

Preferably, the monitoring sub-unit includes:

a first monitoring sub-unit configured to monitor whether the second electronic device corresponding to the information obtained by the information obtaining unit is located in a preset distance from the first electronic device at a current moment; and

the short-distance transmission unit includes:

a first short-distance transmission unit configured to send the first data to the second electronic device through the first wireless transmission channel directly connected between the first electronic device and the second electronic device, in the case where the first monitoring sub-unit monitors the second electronic device in the preset distance from the first electronic device at the current moment.

Preferably, the apparatus further includes:

a network transmission unit configured to in the case where the first monitoring sub-unit monitors that there is not the second electronic device in the preset distance from the first electronic device at the current moment, establish a second transmission channel between the first electronic device and a predetermined server, and send second data to a predetermined server through the second transmission channel, wherein the second electronic device obtains the second data via the specified server, and an amount of information in the second data is the same as an amount of information in the first data.

Preferably, the apparatus further includes:

a data processing unit configured to process the first data to obtain the second data, in the case where the first monitoring sub-unit monitors that there is not the second electronic device in the preset distance from the first electronic device at the current moment, wherein a data quantity of the second data is less than a data amount of the first data.

Preferably, the apparatus further includes:

a short-distance retransmission unit configured to determine that the second electronic device is located in the preset distance from the first electronic device, after sending second data to the predetermined server through the second transmission channel; and transmit the first data to the second electronic device through the first wireless transmission channel directly connected between the first electronic device and the second electronic device, after sending second data to the specified server through the second transmission channel, and detecting that the second electronic device is located in the preset distance from the first electronic device.

Preferably, the monitoring sub-unit includes:

a second monitoring sub-unit configured to monitor whether a second electronic device corresponding to the information obtained by the information obtaining unit is located in a preset distance from the first electronic device, until the second electronic device in the preset distance is monitored.

Preferably, the determination unit includes:

a first data determination unit configured to determine the first data which is set as transmission data in the first electronic device; and

the monitoring unit includes:

a first monitoring unit configured to monitor whether at least one second electronic device is located in the preset distance from the first electronic device, in the case that it is detected that a predetermined condition is met at a current moment.

Preferably, the apparatus further includes:

an access point establishment unit configured to control a wireless communication module of the first electronic device to serve as a wireless access point, wherein a signal sent by the wireless access point covers a preset distance from the first electronic device; and

the monitoring unit includes:

a channel monitoring unit configured to monitor whether a second electronic device establishing the first wireless transmission channel directly connected to the wireless access point is located in the preset distance.

Preferably, the monitoring unit includes:

an access point monitoring unit configured to monitor whether a second electronic device serving as a wireless access point is located in a preset distance from the first electronic device, wherein a wireless communication module of the second electronic device serves as the wireless access point, and a signal sent by the wireless access point at least covers a preset distance from the second electronic device; and

the short-distance transmission unit includes:

a channel establishment unit configured to establish a first wireless transmission channel directly connected between the first electronic device and the wireless access point, in the case where the second electronic device is monitored by the access point monitoring unit; and

a transmission sub-unit configured to send the first data to the second electronic device through the first wireless transmission channel.

With the above technical solutions according to the disclosure, after first data to be transmitted in the first electronic device is determined and in the case where it is detected that a second electronic device is located in the preset distance from the first electronic device, data may be transmitted to the second electronic device through a first wireless transmission channel directly connected between the first electronic device and the second electronic device. In this way, a data sending operation does not need to be triggered by other operations of the user, thus simplifying complexity of data transmission.

### BRIEF DESCRIPTION OF THE DRAWINGS

To describe the technical solutions in the embodiments of the disclosure or in the prior art more clearly, the drawings to be used in describing the embodiments or the prior art will be introduced briefly hereinafter. Apparently, the drawings in the following descriptions are only the embodiments of the disclosure, and other drawings can be obtained by those skilled in the art according to the provided drawings without creative effort.

FIG. 1 shows a schematic flowchart of a data transmission method according to an embodiment of the disclosure;

FIG. 2 shows a schematic flowchart of a data transmission method according to another embodiment of the disclosure;

FIG. 3 shows a schematic flowchart of a data transmission method according to another embodiment of the disclosure;

FIG. 4 shows a schematic flowchart of a data transmission method according to another embodiment of the disclosure;

FIG. 5 shows a schematic flowchart of a data transmission method according to another embodiment of the disclosure;

FIG. 6 shows a schematic structural diagram of a data transmission apparatus according to an embodiment of the disclosure; and

FIG. 7 shows a schematic structural diagram of a data transmission apparatus according to another embodiment of the disclosure.

### DETAILED DESCRIPTION

The technical solutions in the embodiments of the present invention will be described clearly and completely hereinafter in conjunction with the drawings in the embodiments of the disclosure. Apparently, the embodiments described are only a part but not all of the embodiments of the disclosure. All the other embodiments obtained by those skilled in the art without creative effort on the basis of the embodiments of the disclosure fall within the scope of protection of the present invention.

A data transmission method is provided according to an embodiment of the disclosure, to improve the flexibility and convenience of data transmission.

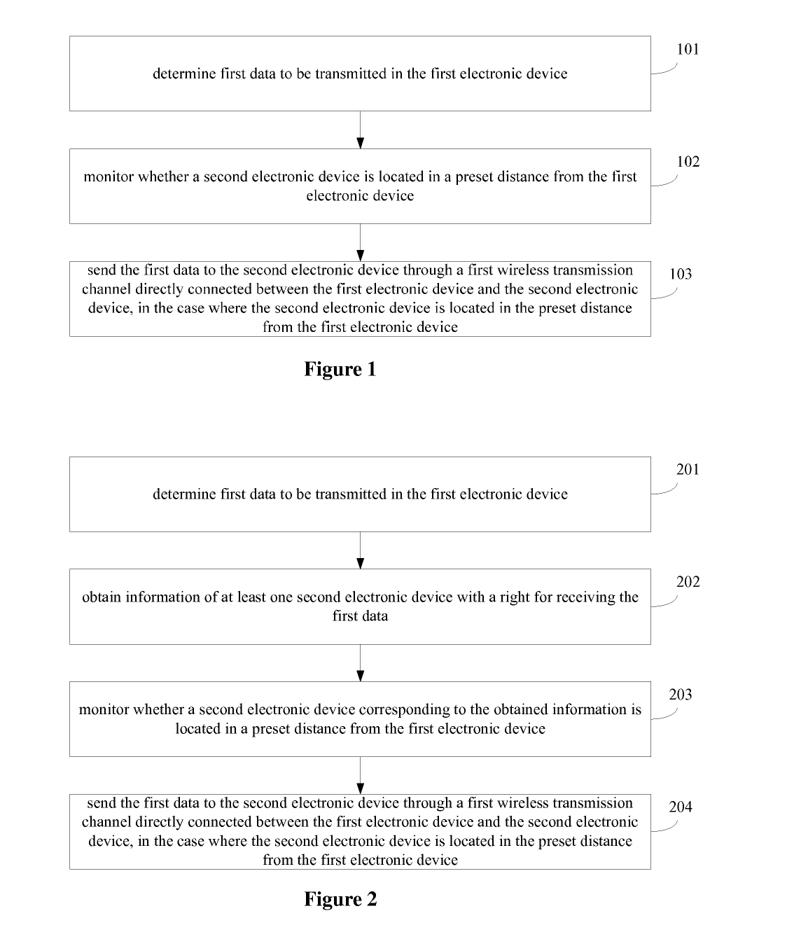

Referring to FIG. 1, a schematic flowchart of a data transmission method according to an embodiment of the disclosure is shown. The method according to the embodiment is applied to a first electronic device, which may be a mobile terminal such as a cell phone or pad, or may also be a laptop computer, etc. The method according to the embodiment may include steps S101, S102, and S103.

S101, determining first data to be transmitted in the first electronic device.

The first data may be data such as a picture, a multimedia, or a document, or may be a folder, etc.

The first data to be transmitted may be preset by a user, or may also be data to be transmitted, where the data is selected by a user from data in the first electronic device in a timely manner.

S102, monitoring whether a second electronic device is located in a preset distance from the first electronic device.

The preset distance depends generally on a coverage area of a signal in short-distance transmission, and may be set according to actual needs.

The second electronic device and the first electronic device are different, which are differentiated for the purpose of a convenient description. In a practical application, the first electronic device and the second electronic device may be different types of devices, or may also be the same type of devices. For example, the first electronic device may be a cell phone, and the second electronic device may be another cell phone.

It should be noted that one or more single second electronic devices are located in the preset distance from the first electronic device. Therefore, it is understood that in the step, at least one second electronic device may be monitored in the preset distance from the first electronic device.

It can be understood that: in an existing short-distance wireless transmission communication technology, other electronic devices within a specified distance around an electronic device needs to be detected. In the embodiment, whether a second electronic device is located in a preset distance from the first electronic device may be monitored in a detection mode in the any existing short-distance wireless transmission communication technology, which will not be limited herein.

S103, sending the first data to the second electronic device through a first wireless transmission channel directly connected between the first electronic device and the second electronic device, in the case where the second electronic device is located in the preset distance from the first electronic device.

In the case where at least one second electronic device may be detected in the preset distance from the first electronic device, for each second electronic device, the first data may be sent to the second electronic device through a first wireless transmission channel directly connected between the first electronic device and the second electronic device.

The first wireless transmission channel is a short-distance wireless transmission channel. When different short-distance communication technologies are employed, the wireless transmission channels are also different correspondingly.

In the embodiment, after first data to be transmitted in the first electronic device is determined by the first electronic device and in the case where it is detected that the second electronic device is located in the preset distance from the first electronic device, data may be transmitted to the second electronic device through a first wireless transmission channel directly connected between the first electronic device and the second electronic device. In this way, a data sending operation does not need to be triggered by other operations of the user, thus simplifying complexity of data transmission.

The data transmission method according to the embodiment of the disclosure may perform based on any existing short-distance wireless transmission mode.

Optionally, in order to transmit data more efficiently, a wireless communication module of an electronic device may be set as a wireless access point (AP), and other electronic devices may access the wireless access point, thus implementing short-distance wireless transmission between devices. Specifically, there may be two implementation modes.

One of the implementation modes is that: a wireless communication module of the first electronic device may be controlled to serve as a wireless access point, and a signal of the wireless access point can cover a preset distance from the first electronic device. In this way, it may be monitored whether the second electronic device is located in the preset distance covered by the signal of the wireless access point. The second electronic device is an electronic device establishing a wireless access point directly connected to the wireless access point.

Specifically, after the first electronic device is controlled to serve as a wireless access point, other electronic devices may detect the wireless access point in a coverage area of a signal of the wireless access point. Other electronic devices may access the wireless access point after establishing a wireless transmission channel directly connected to the wireless access point in a link layer. Thus, the first electronic device may detect other electronic devices which access the wireless access point.

In the coverage area of the signal of the wireless access point, an electronic device accessing the wireless access point is the second electronic device, and there may be a plurality of second electronic devices. A directly connected wireless transmission channel may be established between the wireless access point and any one of the second electronic devices. For the purpose of convenient differentiation, the wireless transmission channel directly connected between the first electronic device and the second electronic device is referred to as a first wireless transmission channel.

In the above situation, the first electronic device may monitor the second electronic device in the preset area, i.e., an electronic device establishing a first wireless transmission channel directly connected to the wireless access point of the first electronic device. Therefore, the first electronic device no longer needs to establish a first wireless transmission channel with the second electronic device.

The other one of the implementation modes is that: the other electronic device in a preset distance from the first electronic device, i.e. the second electronic device, may control wireless communication module thereof as a wireless access point. The first electronic device may detect which wireless access points exist in the preset distance, and may determine which second electronic devices exist in the preset distance.

In this way, the step of monitoring whether a second electronic device is located in a preset distance from the first electronic device may include: monitoring whether a second electronic device serving as a wireless access point is located in a preset distance from the first electronic device. Specifically, the second electronic device control a wireless communication module thereof to serve as a wireless access point, and a signal of the wireless access point can at least cover a preset distance from the second electronic device. Thus, the second electronic device serving as the wireless access point can be detected by the first electronic device, when the distance between the first electronic device and the second electronic device is in the preset distance.

In this situation, if the first electronic device needs to transmit data to the second electronic device, a directly connected first wireless transmission channel needs to be established between the first electronic device and the detected wireless access point. The first data may be transmitted to the second electronic device through the first wireless transmission channel.

In order to ensure the security of data transmission, an electronic device with a right for receiving the first data may be set, and the first data is sent only to the electronic device with the receiving right. Referring to FIG. 2, a schematic flowchart of a data transmission method according to another embodiment of the disclosure is shown. The method according to the embodiment may be applied to a first electronic device, which may be a cell phone, pad, or a laptop computer, etc. The method according to the embodiment includes steps S201, S202, S203, and S204.

S201, determining first data to be transmitted in the first electronic device.

The determined first data may be selected or set by a user. Alternatively, the data to be transmitted may be data, the type of which is predetermined by the user. Thus, the predetermined type of data is determined as data to be transmitted. For example, a photo may be set as data to be transmitted.

S202, obtaining information of at least one second electronic device with a right for receiving the first data.

The information of the second electronic device may be information for identifying the second electronic device. In a practical application of short-distance wireless communication, a user of an electronic device generally uses a user identifier to identify the electronic device. In this situation, the obtained information of the second electronic device may be a user identifier corresponding to the second electronic device. For example, a user name “Spiderman” is used, when a user A uses a second electronic device N to carry out short-distance wireless communication, and the information of the second electronic device is information of an electronic device identified by “Spiderman”.

Specifically, obtaining information of the second electronic device with a right for receiving the first data may include: receiving information of the second electronic device, where the information is input or selected by a user serve as information of the electronic device with a right for receiving the first data.

For example, when the first electronic device has already carried out short-distance wireless data transmission with other electronic device, the first electronic device may save information of the corresponding electronic device, such as a user name or identifier corresponding to the electronic device. In this way, a user may select information of the second electronic device from the information of the electronic device saved by the first electronic device. As another example, information of a second electronic device may be input into the first electronic device by a user, and thus the information of the second electronic device with the right for receiving the first data is obtained.

The information of the second electronic device, which is input or selected by a user, may be received in a timely manner. In addition, information of a second electronic device with the right for receiving the first data may be preset by a user. In this way, information of a second electronic device may be obtained directly from preset right information.

Optionally, an association relationship between information for identifying an electronic device in short-distance wireless data transmission and a corresponding record in an address book of the first electronic device may be established in the first electronic device, which is convenient for user to select an electronic device with the right for receiving the first data. In this way, when a user needs to select a second electronic device with the right for receiving the first data, the user only needs to select contact information corresponding to the second electronic device from the address book of the first electronic device. After receiving a contact selected by a user, the first electronic device may determine a second electronic device corresponding to the contact, according to the preset association relationship.

For example, contact information for both of Zhang san and Li si is recorded in the address book of the first electronic device, and Zhang san use an electronic device A carries out a short-distance wireless communication. When a name “Superman” is used to identify the electronic device A, an association relationship between “Superman” and a contact record of Zhang san in the address book may be established. If a user of the first electronic device wishes to transmit data for Zhang san by means of the short-distance wireless communication, the user may select Zhang san from the address book. In this way, the device A corresponding to “Zhang san” and named “Superman” may be recognized by the first electronic device. In S203, monitoring whether a second electronic device corresponding to the obtained information is located in a preset distance from the first electronic device.

In the embodiment, the second electronic device corresponds to the obtained information, and the second electronic device has the right for receiving the first data. For example, the obtained information of the second electronic devices is “Spiderman” and “Superman” respectively, and thus whether second electronic devices corresponding to “Spiderman” and “Superman” are located in the preset distance from the first electronic device is monitored.

An implementation mode of monitoring whether a second electronic device is located in the preset area may be referred to a related introduction of any of the above embodiments, which will not be described in detail herein.

S204, sending the first data to the second electronic device through a wireless transmission channel directly connected between the first electronic device and the second electronic device, in the case where the second electronic device is located in the preset distance from the first electronic device.

In the embodiment, after first data to be transmitted is determined, it is required to obtain the information of the second electronic device with a right for receiving the first data, and thus whether the second electronic device corresponding to the obtained information is located in the preset distance is monitored. In this way, even if other electronic devices in addition to the second electronic device are located in the preset distance from the first electronic device, the first electronic device would not transmit data to other electronic devices, and thus improving the security of data transmission.

Also, in the case where a user of the first electronic device can determine the information of the second electronic device for receiving the first data, compared with the solution in which a first electronic device searches for other electronic devices in a preset distance from the first electronic device and the user selects a second electronic device from the searched other electronic devices, a user does not need to wait for a process of searching for surrounding electronic devices by the first electronic device, and a process of searching for a second electronic device and transmitting data may be automatically performed by the first electronic device without user participation according to the embodiment, therefore time consumption of user operation is reduced greatly.

In order to facilitate understanding, transmitting data in a timely manner is taken as an example. In the case where a user of a first electronic device needs to send data to a second electronic device with a user name “Superman”, the user may select, from the first electronic device, data to be transmitted; and may select the “Superman” from the saved user identifiers or input the name “Superman”. Then, the user may consider a data transmission process to be an end, and does not need to wait any more. However, after obtaining identification information corresponding to the second electronic device, the first electronic device may search for the second electronic device as a wireless access point in a preset distance. Once the second electronic device is searched, the first electronic device establishes a wireless transmission channel directly connected to the wireless access point, and transmits the first data to the second electronic device through the wireless transmission channel. Thus, a user does not need to wait after selecting or inputting a name of a second electronic device, and the time of the user may be saved greatly.

Of course, in the embodiment, an implementation of a short-distance transmission is introduced by serving a wireless communication module of an electronic device as a wireless access point. The processes of other short-distance wireless transmission are similar to this, which will not be described in detail herein.

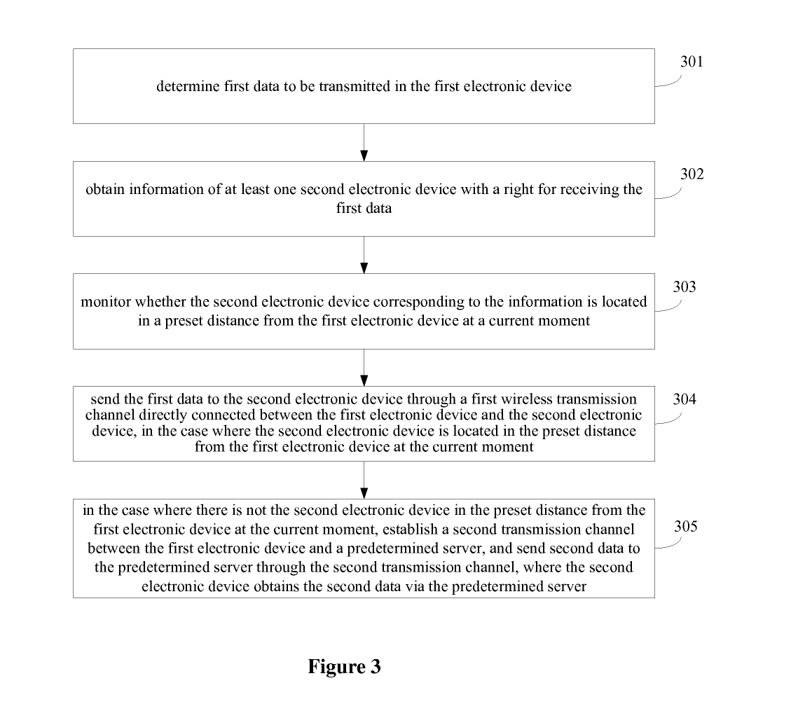

Referring to FIG. 3, a schematic flowchart of a data transmission method according to another embodiment of the disclosure is shown. The method according to the embodiment is applied to a first electronic device, which may be a cell phone, a pad, or a laptop computer, etc. The method according to the embodiment may include steps S301, S302, S303, S304 and S305.

S301, determining first data to be transmitted in the first electronic device.

S302, obtaining information of at least one second electronic device with a right for receiving the first data.

S303, monitoring whether the second electronic device corresponding to the information is located in a preset distance from the first electronic device at a current moment.

S304, sending the first data to the second electronic device through a wireless transmission channel directly connected between the first electronic device and the second electronic device, in the case where the second electronic device is located in the preset distance from the first electronic device at a current moment.

In the embodiment, a condition to send the first data to the second electronic device is that: the second electronic device is monitored in the preset distance from the first electronic device at a current time during the monitoring.

S305, in the case where there is not the second electronic device in the preset distance from the first electronic device at the current moment, establishing a second transmission channel between the first electronic device and a predetermined server, and sending second data to the predetermined server through the second transmission channel. The second electronic device obtains the second data via the predetermined server.

An amount of information in the second data is the same as that an amount of information in the first data, which means that information acquired from the first data by the user is the same as information acquired from the second data by the user. The amount of information obtained by user may not depend on the first data and the second data. For example, the first data may include a notification content, and the second data may also include the notification content. Thus, the user may obtain the notification content from each of the first data and the second data.

After the second data is transmitted to the predetermined server, the specified server predetermined may transmit the second data to the second electronic device. Alternatively, the predetermined server may also send information to instruct the second electronic device to read the second data.

In the embodiment, in the case where a user needs to transmit the first data to the second electronic device, the first data to be transmitted may be selected by the user, and then the first electronic device obtains information of the second electronic device with the receiving right. In the case where it is monitored the second electronic device in a preset distance from the first electronic device at a current time, the first data is transmitted to the second electronic device through a directly connected first wireless transmission channel established between the first electronic device and the second electronic device, so as to avoid occupying extranet resources. In the case where it can not be monitored the second electronic device in a preset distance from the first electronic device at a current time, a second transmission channel to a predetermined server is established. The second electronic device may obtain the first data through the predetermined server, thus improving the reliability of data transmission.

In a practical application, the first data of the embodiment may be the same as the second data of the embodiment. That is, the first data may be transmitted directly to the specified server.

Optionally, since data is transmitted over a network, there is a disadvantage of slow data transmission. Before transmitting the data to the predetermined server, the first data may also be processed to obtain a second data. A data quantity of the second data is less than a data quantity of the first data. For example, the first data is compressed to obtain the second data. The data quantity of the second data is less than the data quantity of the first data, and thus time consumption for transmitting data to the predetermined server may be reduced greatly.

Further, in the case where the first electronic device sends to the predetermined server the second data obtained by compressing the first data, in order to allow a user of the second electronic device to obtain the unprocessed first data, the first electronic device may continue to monitor whether the second electronic device is located in the preset distance from the first electronic device after sending the second data to the predetermined server through the second transmission channel. When it is monitored the second electronic device in the preset distance from the first electronic device, the first electronic device transmit the first data to the second electronic device through the first wireless transmission channel directly connected between the first electronic device and the second electronic device.

After the second data having a less data quantity is sent to the second electronic device, if it is monitored the second electronic device in the preset distance from the first electronic device, the first data is sent to the second electronic device, a user of the second electronic device may obtain clearer or more complete content. For example, when the second electronic device is a thumbnail of an image or a web page, although a user can view the content of the whole image or web page, the viewing effect is poor. However, after resending the first data to the second electronic device, a complete picture of the image or web page may be present to the user, and the viewing effect is better.

Particularly, to monitor whether the second electronic device is located in the preset distance from the first electronic device, a wireless communication module of the first electronic device is set as a wireless access point, which may result in a failure connection of the first electronic device to connect the network server. In this case, data can not be transmitted over Internet. Therefore, in the embodiment, in the case where the second electronic device can not be monitored in the preset distance from the first electronic device at a current time, setting the wireless communication module as the wireless access point may be cancelled to restore a normal wireless communication function of the wireless communication module, and the first electronic device may send the second data via the predetermined server. After the first electronic device send the second data to the predetermined server, the wireless communication module of the first electronic device may further be controlled to server as the wireless access point, and the first electronic device may continue to monitor whether the second electronic device appears in the preset distance from the first electronic device.

Of course, in a practical application, in the case where the second electronic device can not be monitored in the preset distance from the first electronic device at a current time, the wireless communication module may also be periodically controlled to serve as the wireless access point according to a preset period. After the preset period in which the wireless communication module is controlled to serve as the wireless access point, setting the wireless communication module as the wireless access point is cancelled.

Optionally, the electronic device may include two wireless communication modules. One of the two wireless communication modules may be controlled to serve as the wireless access point, and the other one of the two wireless communication modules may be configured to connect other network servers.

Referring to FIG. 4, a schematic flowchart of a data transmission method according to another embodiment of the disclosure is shown. The method according to the embodiment is applied to a first electronic device, which may be a cell phone, a pad, or a laptop computer, etc. The method according to the embodiment may include steps S401, S402, S403, and S404.

S401, determining first data to be transmitted in the first electronic device.

S402, obtaining information of at least one second electronic device with a right for receiving the first data.

S403, monitoring whether a second electronic device corresponding to the information is located in a preset distance from the first electronic device, until the second electronic device in the preset distance is monitored.

S404, sending the first data to the second electronic device through a wireless transmission channel directly connected between the first electronic device and the second electronic device, in the case where the second electronic device in the preset distance from the first electronic device is monitored at a current time.

Once obtaining the information of the second electronic device with the right for receiving the first data, the first electronic device may carry out the monitoring continuously Alternatively, when the monitoring may be performed in a timely manner, the first electronic device may also be triggered to monitor, in a preset time interval, whether there exists a second electronic device corresponding to the information in a preset distance from the first electronic device, until the second electronic device is monitored. In this way, the data transmission to the second electronic device is implemented.

In the embodiment, after a second electronic device for receiving the first data is set by the user, when the first data needs to be transmitted, in the case where the second electronic device can not be monitored in the preset distance from the first electronic device at a current time, the first electronic device may continue the monitoring, until the second electronic device is monitored finally, thus ensuring that the data can be transmitted finally to the second electronic device.

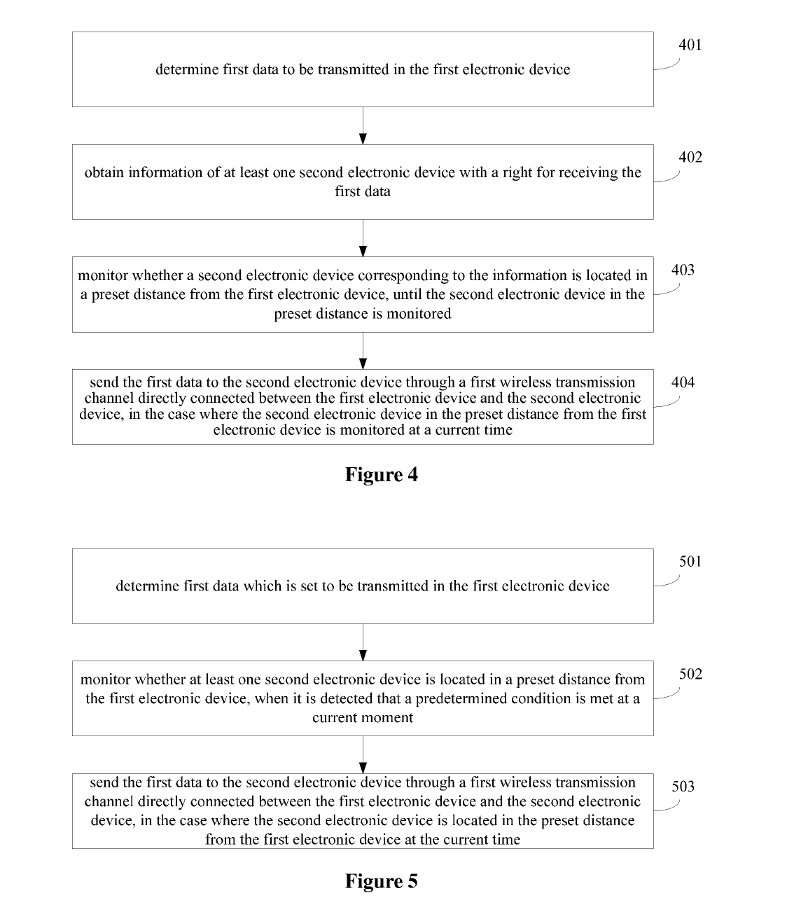

Referring to FIG. 5, a schematic flowchart of a data transmission method according to another embodiment of the disclosure is shown. The method according to the embodiment may be applied to a first electronic device, which may be a cell phone, a pad, or a laptop computer, etc. The method according to the embodiment may include steps S501, S502, and S503.

S501, determining first data which is set to be transmitted in the first electronic device.

In the embodiment, the step may be similar to that in any one of the above embodiments, that is, the step of determining first data may include: receiving data to be transmitted in the case where a sending request of a user is received, where the data is selected from the data in first electronic device by the user to determine the first data.

Additionally, in the embodiment, the step of determining the first data may include: after a user sets the first data required to be transmitted, determining, by the first electronic device, the first data to be transmitted when a specific condition is met. As an example, whether the first data to be transmitted exists in the first electronic device is detected in a preset time interval, and then the data to be transmitted is determined.

S502, monitoring whether at least one second electronic device is located in a preset distance from the first electronic device, when it is detected that a predetermined condition is met at a current moment.

The predetermined condition may be set by a user as required, or may also be a preset unchangeable condition.

For example, the predetermined condition may be a preset period. After the first data to be transmitted is determined, when a predetermined monitoring time arrives according to the preset period, an operation of monitoring whether at least one second electronic device is located in a preset distance from the first electronic device may be carried out.

As another example, the predetermined condition may be that: a time period from a time when the first data is determined to a current time reaches a certain time period. For example, after the first data is selected by a user, it is determined that the first data is transmitted after two hours. In this case, the monitoring operation is carried out after two hours since the first electronic device detects that the user selects the first data.

Optionally, a user may set a data transmission time corresponding to the first data, which is called a first data transmission time corresponding to the first data for the purpose of convenient description. That is, the first data to be transmitted that is determined by the first electronic device has the corresponding first data transmission time. Accordingly, the predetermined condition may be that a current time is the first data transmission time. When the first data transmission time arrives, whether at least one second electronic device is located in a preset distance from the first electronic device is monitored. In the case where the user wishes to transmit data at a certain time to implement data sharing, if the user needs to handle other transactions at the certain time or worries that he will forget to transmit the data, the first data transmission time corresponding to the first data may be preset. When the first data transmission time arrives, the first electronic device may carry out the monitoring operation, and may transmit the first data to the at least one second electronic device by subsequent operations, thus implementing data sharing.

Optionally, the predetermined condition may also be that: a current location of the first electronic device is a set location, or a distance between a location of the first electronic device and a certain type of place is less than a preset value. As an example, the first electronic device may determine its own geographical location in some ways, such as GPS positioning. If the geographical location is the set location, whether the second electronic device is located in the preset distance from the first electronic device is monitored.

As an example, the first electronic device may position its own geographical location, and determine a place within a specified area of the geographical location. When the place within the specified area is the specified type of place, whether the second electronic device is located in the preset distance from the first electronic device is monitored. The specified type of place may be a place such as a subway station. In the specified type of place, the first electronic device may not be connected because an extranet such as an internet can not be used. In this case, the short-distance transmission mode may be used to transmit data.

S503, sending the first data to the second electronic device through a wireless transmission channel directly connected between the first electronic device and the second electronic device, in the case where the second electronic device is located in the preset distance from the first electronic device at the current time.

Optionally, in order to ensure the security of data transmission, information of at least one second electronic device with a right for receiving the first data may also be obtained before the step S502. In the step S502, whether a second electronic device corresponding to the obtained information is located in a preset distance from the first electronic device may be monitored.

It should be understood that, in the embodiment, when monitoring whether the second electronic device is located in a preset distance from the first electronic device, a wireless communication module of the first electronic device is set as a wireless access point, which may result in a failure connection between the first electronic device and the other network device. Thus, data can not be transmitted over an extranet, etc. Therefore, in a practical application, a wireless communication module of the first electronic device may be set as a wireless access point when it is judged that a current time is a time meeting a predetermined condition. Specifically, the wireless communication module may serves as the wireless access point for a preset time period under the control. After the preset time period arrives, setting the wireless communication module as the wireless access point may be cancelled to restore the network connection function of the wireless communication module to other network devices.

After the wireless communication module of the first electronic device is set as a wireless access point, in the case where the second electronic device can not be monitored in the preset distance from the first electronic device at a current time, setting the wireless communication module as the wireless access point may also be cancelled immediately.

Optionally, the electronic device may include two wireless communication modules. In this case, one of the two wireless communication modules may be controlled to serve as the wireless access point, and the other one of the two wireless communication modules may be configured to connect to other network devices.

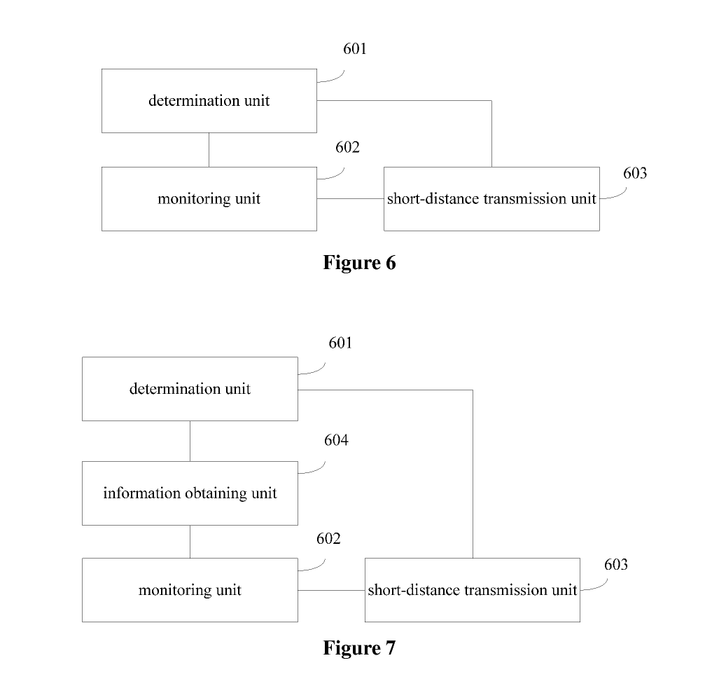

Correspondingly to a data transmission method according to the disclosure, a data transmission apparatus is provided. Referring to FIG. 6, a schematic structural diagram of a data transmission apparatus according to an embodiment of the disclosure is shown. The apparatus according to the embodiment is applied to a first electronic device, which may be a cell phone, a pad, or a laptop computer, etc. The apparatus according to the embodiment may include: a determination unit 601, a monitoring unit 602, and a short-distance transmission unit 603.

The determination unit 601 is configured to determine first data to be transmitted in the first electronic device.

The monitoring unit 602 is configured to monitor whether a second electronic device is located in a preset distance from the first electronic device.

The short-distance transmission unit 603 is configured to send the first data determined by the determination unit to the second electronic device through a first wireless transmission channel directly connected between the first electronic device and the second electronic device, in the case where the second electronic device is located in the preset distance from the first electronic device.

In the embodiment, after first data is determined by the determination unit and in the case where the monitoring unit monitors a second electronic device in the preset distance from the first electronic device, the short-distance wireless transmission unit sends the first data to the second electronic device through the first wireless transmission channel directly connected between the first electronic device and the second electronic device. Thus, the data transmission may be implemented, which no longer requires to trigger a data transmission operation through other operations of the user, thus simplifying the complexity of data transmission.

In order to implement a short-distance data transmission, optionally, in an implementation, the apparatus according to the embodiment further includes:

an access point establishment unit configured to control a wireless communication module of the first electronic device to serve as a wireless access point. The signal sent by the wireless access point covers a preset distance from the first electronic device.

The monitoring unit includes:

a channel monitoring unit configured to monitor whether a second electronic device establishing the first wireless transmission channel directly connected to the wireless access point is located in the preset distance.

In order to implement the short-distance data transmission, optionally, in another implementation, the apparatus according to the embodiment further includes:

an access point monitoring unit configured to monitor whether a second electronic device serving as a wireless access point is located in a preset distance from the first electronic device. A wireless communication module of the second electronic device serves as the wireless access point, and a signal sent by the wireless access point at least covers a preset distance from the second electronic device.

Accordingly, the short-distance transmission unit includes:

a channel establishment unit configured to establish a first wireless transmission channel directly connected between the first electronic device and the wireless access point, in the case where the second electronic device is monitored by the access point monitoring unit; and

a transmission sub-unit configured to send the first data to the second electronic device through the first wireless transmission channel.

Referring to FIG. 7, a schematic structural diagram of a data transmission apparatus according to another embodiment of the disclosure is shown. The apparatus according to the embodiment may be applied to a first electronic device. The embodiment differs from an embodiment shown as FIG. 6 in that the apparatus according to the embodiment further includes an information obtaining unit 604.

The information obtaining unit 604 is configured to obtain information of at least one second electronic device with a right for receiving the first data determined by the determination unit.

Accordingly, the monitoring unit 603 may include:

a monitoring sub-unit configured to monitor whether a second electronic device corresponding to the information obtained by the information obtaining unit is located in a preset distance from the first electronic device.

On the basis of the embodiment of FIG. 7, in one aspect of the disclosure, the monitoring sub-unit may include:

a first monitoring sub-unit configured to monitor whether the second electronic device corresponding to the information obtained by the information obtaining unit is located in a preset distance from the first electronic device at a current moment.

Accordingly, the short-distance transmission unit includes:

a first short-distance transmission unit configured to send the first data to the second electronic device through the first wireless transmission channel directly connected between the first electronic device and the second electronic device, in the case where the first monitoring sub-unit monitors that the second electronic device is located in the preset distance from the first electronic device at the current moment.

Optionally, the apparatus further includes:

a network transmission unit configured to in the case where the first monitoring sub-unit monitors that there is not the second electronic device in the preset distance from the first electronic device at the current moment, establish a second transmission channel between the first electronic device and a specified server, and send second data to a predetermined server through the second transmission channel. The second electronic device obtains the second data via the specified server, and an amount of information in the second data is the same as an amount of information in the first data.

Specifically, the first data may be the same as the second data.

Further, the apparatus also includes:

a data processing unit configured to process the first data to obtain the second data, in the case where the first monitoring sub-unit monitors that there is not the second electronic device in the preset distance from the first electronic device at the current moment. A data quantity of the second data is less than a data amount of the first data.

In the case where the data quantity of the second data is a less than a data amount of the first data, the apparatus further includes:

a short-distance retransmission unit configured to determine that the second electronic device is located in the preset distance from the first electronic device, after sending second data to the predetermined server through the second transmission channel; and transmit the first data to the second electronic device through the first wireless transmission channel directly connected between the first electronic device and the second electronic device.

On the basis of the embodiment of FIG. 7, in another aspect of the disclosure, the monitoring sub-unit may include:

a second monitoring sub-unit configured to monitor whether a second electronic device corresponding to the information obtained by the information obtaining unit is located in a preset distance from the first electronic device, until the second electronic device in the preset distance is monitored.

On the basis of any one of the embodiments, the determination unit may include:

a first data determination unit configured to determine the first data as transmission data in the first electronic device.

Accordingly, the monitoring unit includes:

a first monitoring unit configured to monitor whether at least one second electronic device is located in a preset distance from the first electronic device, in the case that it is detected that a predetermined condition is met at a current moment.

Optionally, the first data determined by the first data determination unit corresponds to a first data transmission time.

Accordingly, the first monitoring unit monitors whether at least one second electronic device is located in the preset distance from the first electronic device, at the first data transmission time corresponding to the first data.

In the present specification, the embodiments are described in progression, each embodiment mainly focuses on the difference between itself and other embodiments, and reference can be made to these similar parts between the embodiments. For the apparatus disclosed in the embodiments, it corresponds to the method disclosed in the embodiments, therefore it is described simply, and for the relevant portions, one can refer to explanations of the method part.

The above descriptions of the disclosed embodiments enable those skilled in the art to implement or use the present disclosure. Various modifications made to those embodiments will be obvious to those skilled in the art, and the ordinal principles defined in the present disclosure can be implemented in other embodiments without departing from the spirit or the scope of the present disclosure. Therefore, the disclosure should not be limited to those embodiments disclosed herein, but should be in coincidence with the widest scope in accordance with the principles and the novel characteristics disclosed in the disclosure.

1. A data transmission method, applied to a first electronic device, wherein the method comprises:
determining first data to be transmitted in the first electronic device;
monitoring whether a second electronic device is located in a preset distance from the first electronic device; and
sending the first data to the second electronic device through a first wireless transmission channel directly connected between the first electronic device and the second electronic device, in the case where the second electronic device is located in the preset distance from the first electronic device.

2. The method according to claim 1, wherein before the monitoring whether a second electronic device is located in a preset distance from the first electronic device, the method further comprises:
obtaining information of at least one second electronic device with a right for receiving the first data; and
wherein the monitoring whether a second electronic device is located in a preset distance from the first electronic device comprises:
monitoring whether a second electronic device corresponding to the information is located in the preset distance from the first electronic device.

3. The method according to claim 2, wherein the monitoring whether a second electronic device corresponding to the information is located in a preset distance from the first electronic device comprises:
monitoring whether a second electronic device corresponding to the information is located in the preset distance from the first electronic device at a current moment; and
wherein the sending the first data to the second electronic device through a first wireless transmission channel directly connected between the first electronic device and the second electronic device, in the case where the second electronic device is located in the preset distance from the first electronic device comprises:
sending the first data to the second electronic device through a first wireless transmission channel directly connected between the first electronic device and the second electronic device, in the case where the second electronic device is located in the preset distance from the first electronic device at the current moment.

4. The method according to claim 3, further comprising: in the case where there is not the second electronic device in the preset distance from the first electronic device at the current moment, establishing a second transmission channel between the first electronic device and a predetermined server, and sending second data to the predetermined server through the second transmission channel, wherein the second electronic device obtains the second data via the predetermined server, and an amount of information in the second data is the same as an amount of information in the first data.

5. The method according to claim 4, wherein in the case where there is not the second electronic device in the preset distance from the first electronic device at the current moment, before the sending second data to the predetermined server through the second transmission channel, the method further comprises:
processing the first data to obtain the second data, wherein a data quantity of the second data is less than a data quantity of the first data.

6. The method according to claim 5, wherein after the sending second data to the predetermined server through the second transmission channel, the method further comprises:
transmitting the first data to the second electronic device through the first wireless transmission channel directly connected between the first electronic device and the second electronic device, in the case where it is detected that the second electronic device is located in the preset distance from the first electronic device.

7. The method according to claim 2, wherein the monitoring whether a second electronic device is located in a preset distance from the first electronic device comprises:
monitoring whether a second electronic device corresponding to the information is located in a preset distance from the first electronic device, until the second electronic device in the preset distance is monitored.

8. The method according to claim 1, wherein the determining first data to be transmitted in the first electronic device comprises:
Determining the first data which is set as transmission data in the first electronic device; and
wherein the monitoring whether a second electronic device is located in a preset distance from the first electronic device comprises:
monitoring whether at least one second electronic device is located in the preset distance from the first electronic device, in the case that it is detected that a predetermined condition is met at a current moment.

9. The method according to claim 1, wherein before the monitoring whether a second electronic device is located in a preset distance from the first electronic device, the method further comprises:
setting a wireless communication module of the first electronic device as a wireless access point, wherein a signal sent by the wireless access point covers a preset distance from the first electronic device; and
wherein the monitoring whether a second electronic device is located in a preset distance from the first electronic device comprises:
monitoring whether the second electronic device establishing the first wireless transmission channel directly connected to the wireless access point is located in the preset distance.

10. The method according to claim 1, wherein the monitoring whether a second electronic device is located in a preset distance from the first electronic device comprises:
monitoring whether the second electronic device serving as a wireless access point is located in a preset distance from the first electronic device, wherein a wireless communication module of the second electronic device serve as the wireless access point, and a signal sent by the wireless access point at least covers a preset distance from the second electronic device; and
wherein the sending the first data to the second electronic device through a first wireless transmission channel directly connected between the first electronic device and the second electronic device, in the case where the second electronic device is located in the preset distance from the first electronic device, comprises:
establishing a first wireless transmission channel directly connected between the first electronic device and the wireless access point, in the case where the second electronic device is monitored; and
sending the first data to the second electronic device through the first wireless transmission channel.

11. A data transmission apparatus, applied to a first electronic device, wherein the apparatus comprises:
a determination unit configured to determine first data to be transmitted in the first electronic device;
a monitoring unit configured to monitor whether a second electronic device is located in a preset distance from the first electronic device; and
a short-distance transmission unit configured to send the first data determined by the determination unit to the second electronic device through a first wireless transmission channel directly connected between the first electronic device and the second electronic device, in the case where the monitoring unit monitors the second electronic device in the preset distance from the first electronic device.

12. The apparatus according to claim 11, further comprising:
an information obtaining unit configured to obtain information of at least one second electronic device with a right for receiving the first data determined by the determination unit; and
wherein the monitoring unit comprises:
a monitoring sub-unit configured to monitor whether a second electronic device corresponding to the information obtained by the information obtaining unit is located in a preset distance from the first electronic device.

13. The apparatus according to claim 12, wherein the monitoring sub-unit comprises:
a first monitoring sub-unit configured to monitor whether the second electronic device corresponding to the information obtained by the information obtaining unit is located in a preset distance from the first electronic device at a current moment; and
wherein the short-distance transmission unit comprises:
a first short-distance transmission unit configured to send the first data to the second electronic device through the first wireless transmission channel directly connected between the first electronic device and the second electronic device, in the case where the first monitoring sub-unit monitors the second electronic device in the preset distance from the first electronic device at the current moment.

14. The apparatus according to claim 13, further comprising:
a network transmission unit configured to in the case where the first monitoring sub-unit monitors that there is not the second electronic device in the preset distance from the first electronic device at the current moment, establish a second transmission channel between the first electronic device and a predetermined server, and send second data to the predetermined server through the second transmission channel, wherein the second electronic device obtains the second data via the predetermined server, and an amount of information in the second data is the same as an amount of information in the first data.

15. The apparatus according to claim 14, further comprising:
a data processing unit configured to process the first data to obtain the second data, in the case where the first monitoring sub-unit monitors that there is not the second electronic device in the preset distance from the first electronic device at the current moment, wherein a data quantity of the second data is less than a data quantity of the first data.

16. The apparatus according to claim 15, further comprising:
a short-distance retransmission unit configured to determine that the second electronic device is located in the preset distance from the first electronic device, after sending second data to the predetermined server through the second transmission channel; and transmit the first data to the second electronic device through the first wireless transmission channel directly connected between the first electronic device and the second electronic device.

17. The apparatus according to claim 12, wherein the monitoring sub-unit comprises:
a second monitoring sub-unit configured to monitor whether a second electronic device corresponding to the information obtained by the information obtaining unit is located in a preset distance from the first electronic device, until the second electronic device in the preset distance is monitored.

18. The apparatus according to claim 11, wherein the determination unit comprises:
a first data determination unit configured to determine the first data which is set as transmission data in the first electronic device; and
wherein the monitoring unit comprises:
a first monitoring unit configured to monitor whether at least one second electronic device is located in the preset distance from the first electronic device, in the case that it is detected that a predetermined condition is met at a current moment.

19. The apparatus according to claim 11, further comprising:
an access point establishment unit configured to control a wireless communication module of the first electronic device to serve as a wireless access point, wherein a signal sent by the wireless access point covers a preset distance from the first electronic device; and
wherein the monitoring unit comprises:
a channel monitoring unit configured to monitor whether a second electronic device establishing the first wireless transmission channel directly connected to the wireless access point is located in the preset distance.

20. The apparatus according to claim 11, wherein the monitoring unit comprises:
an access point monitoring unit configured to monitor whether a second electronic device serving as a wireless access point is located in a preset distance from the first electronic device, wherein a wireless communication module of the second electronic device serves as the wireless access point, and a signal sent by the wireless access point at least covers a preset distance from the second electronic device; and
wherein the short-distance transmission unit comprises:
a channel establishment unit configured to establish a first wireless transmission channel directly connected between the first electronic device and the wireless access point, in the case where the second electronic device is monitored by the access point monitoring unit; and
a transmission sub-unit configured to send the first data to the second electronic device through the first wireless transmission channel.
